(19) United States
(12) Patent Application Publication
(10) Pub. No.: US 2006/0261603 A1
(43) Pub. Date: Nov. 23, 2006

(54) Safety mechanism for vehicle door latch systems

(76) Inventors: Roman Cetnar, Newmarket (CA); Krystof P. Jankowski, Waterford, MI (US); Zahid Wazir, Newmarket (CA); Gavin Winch, Anten Mills (CA)

Correspondence Address: CLARK HILL, P.C., 500 WOODWARD AVENUE, SUITE 3500, DETROIT, MI, 48226, US

(21) Appl. No.: 11/437,338

(22) Filed: May 19, 2006

Related U.S. Application Data
(60) Provisional application No. 60/682,982, filed on May 20, 2005.
(60) Provisional application No. 60/682,981, filed on May 20, 2005.

(51) Int. Cl. E05C 3/06

(52) U.S. Cl. 292/216

(57) ABSTRACT

A latch assembly selectively engages a striker for latching a door to a motor vehicle body. The latch assembly includes a housing. A ratchet is rotatably mounted to the housing for movement between an engaged position engaging the striker and a release position. A ratchet-engaging pawl is rotatably mounted to the housing and engageable with the ratchet to retain the ratchet in the engaged position. An inertia mechanism is operably connected to the ratchet-engaging pawl to prevent the ratchet-engaging pawl from pivoting out of engagement with the ratchet when the ratchet-engaging pawl begins to pivot due to inertial forces acting thereupon.

### CROSS-REFERENCE TO RELATED APPLICATIONS

This application claims the benefit of and priority to U.S. Provisional Application Ser. No. 60/682,982, entitled “Safety Mechanism for Vehicle Door Latch Systems” and filed May 20, 2005, and U.S. Provisional Application Ser. No. 60/682,981, entitled “Inertia Catch for Door Latches” and filed May 20, 2005.

### FIELD OF THE INVENTION

The invention relates to a latch assembly for selectively locking a motor vehicle door. More particularly, the invention relates to latch assembly including an inertia mechanism for preventing a ratchet from releasing a striker in the event of a motor vehicle impact.

### DESCRIPTION OF RELATED ART

Motor vehicles include hinged doors for selectively providing access to motor vehicle passenger or cargo compartments. Typically, a latch mechanism is coupled between one of the doors and a motor vehicle body for releasably locking the door in a closed position. A release mechanism is typically coupled to the latch mechanism for locking and unlocking the latch mechanism. It remains desirable to provide a mechanism for preventing the latch mechanism from unlocking during a side impact of the motor vehicle.

### SUMMARY OF THE INVENTION

According to one aspect of the invention, a latch assembly selectively engages a striker for latching a door to a motor vehicle body. The latch assembly includes a housing. A ratchet is rotatably mounted to the housing for movement between an engaged position engaging the striker and a release position. A ratchet-engaging pawl is rotatably mounted to the housing and engageable with the ratchet to retain the ratchet in the engaged position. An inertia mechanism is operably connected to the ratchet-engaging pawl to prevent the ratchet-engaging pawl from pivoting out of engagement with the ratchet when the ratchet-engaging pawl begins to pivot due to inertial forces acting thereupon.

According to another aspect of the invention, a latch assembly selectively engages a striker for latching a door to a motor vehicle body. The latch assembly includes a housing. A ratchet is rotatably mounted to the housing for movement between an engaged position engaging the striker and a release position. A ratchet-engaging pawl is engageable with the ratchet to retain the ratchet in the engaged position. The latch assembly also includes an auxiliary pawl lever rotatably mounted to the housing and coupled to the ratchet-engaging pawl for moving the ratchet-engaging pawl out of engagement with the ratchet. The auxiliary pawl lever includes a protrusion extending out therefrom. An inertia mechanism is coupled to the housing and includes a plunger movable in response to inertial forces to effect engagement between the plunger and the protrusion and prevent the auxiliary pawl from moving the ratchet-engaging pawl out of engagement with the ratchet.

According to yet another aspect of the invention, a latch assembly selectively engages a striker for latching a door to a motor vehicle body. The latch assembly includes a housing. A ratchet is rotatably mounted to the housing for movement between an engaged position engaging the striker and a release position. A ratchet-engaging pawl is engageable with the ratchet to retain the ratchet in the engaged position. An auxiliary pawl lever is rotatably mounted to the housing and operably coupled to the ratchet-engaging pawl for moving the ratchet-engaging pawl out of engagement with the ratchet to allow movement of the ratchet to the release position. An inertia mechanism includes a plunger having a first end coupled to the auxiliary pawl lever and an opposing second end. The inertia mechanism includes a bell member having a cavity for receiving the second end during normal latch assembly operation to allow rotation of the auxiliary pawl lever to move the ratchet-engaging pawl out of engagement with the ratchet. The cavity movable out of alignment with the second end of the plunger in response to inertial forces to prevent movement of said plunger into said cavity and rotation of said auxiliary pawl lever.

### BRIEF DESCRIPTION OF THE DRAWINGS

The invention will be readily appreciated as the same becomes better understood by reference to the following detailed description when considered in connection with the accompanying drawings wherein:

FIG. 1 is a fragmentary, perspective view of a motor vehicle including a latch assembly according to one embodiment of the invention fixedly mounted along a door;

FIG. 2 is a perspective view of the latch assembly including a ratchet in an engaged position and a ratchet-engaging pawl engaging the ratchet;

FIG. 3 is a perspective view of the latch assembly including the ratchet in a release position;

FIG. 4 is an exploded, perspective view of the latch assembly including an inertia mechanism and an auxiliary pawl lever operably coupled to the ratchet-engaging pawl;

FIG. 5 is a fragmentary, perspective view of the latch assembly including the inertia mechanism having a plunger in a retracted position;

FIG. 6 is a fragmentary, perspective view of the latch assembly including the plunger in an extended position engaging the auxiliary pawl lever;

FIG. 7 is a cross-sectional view of the latch assembly with the plunger in the retracted position;

FIG. 8 is a cross-sectional view of the latch assembly with the plunger in the extended position engaging the auxiliary pawl lever;

FIG. 9 is a perspective view of a latch assembly according to a second embodiment of the invention including an inertia mechanism having a bell member defining a cavity;

FIG. 10 is a side view of the latch assembly including a plunger in a seated position disposed within the cavity to allow rotation of an auxiliary pawl lever; and

FIG. 11 is a side view of the latch assembly including the bell member moved off center in response to a motor vehicle impact to prevent the plunger from entering the cavity.

### DETAILED DESCRIPTION OF THE PREFERRED EMBODIMENTS

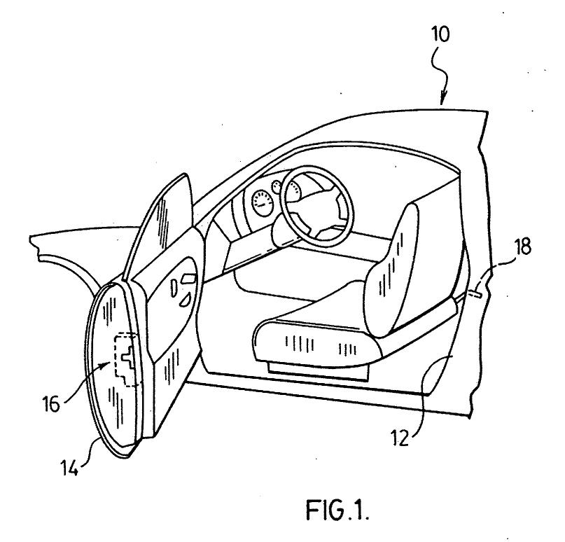

Referring to FIG. 1, a motor vehicle, generally indicated at 10, includes a body portion 12 and a door 14 pivotally hinged to the body portion 12 for movement between an open position and a closed position. A latch assembly, generally shown at 16, is fixedly mounted to the door 14 and selectively engages a striker 18 mounted along the body portion 12. A detailed description of the structure and function of the latch assembly 16 is disclosed in Applicant's U.S. patent application Ser. No. 11/007,946 filed on Dec. 9, 2004, which is incorporated herein by reference in its entirety.

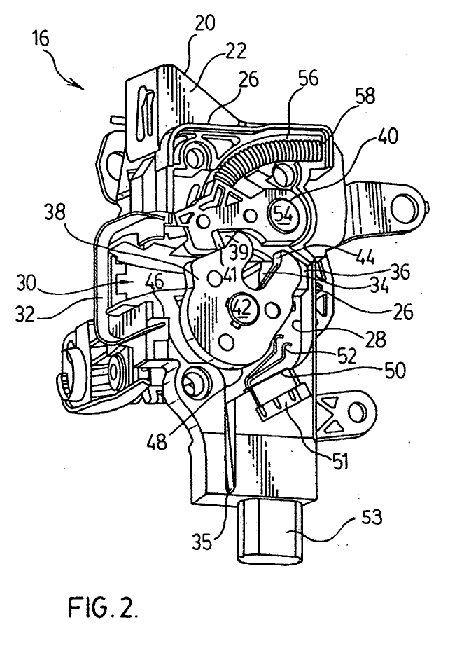

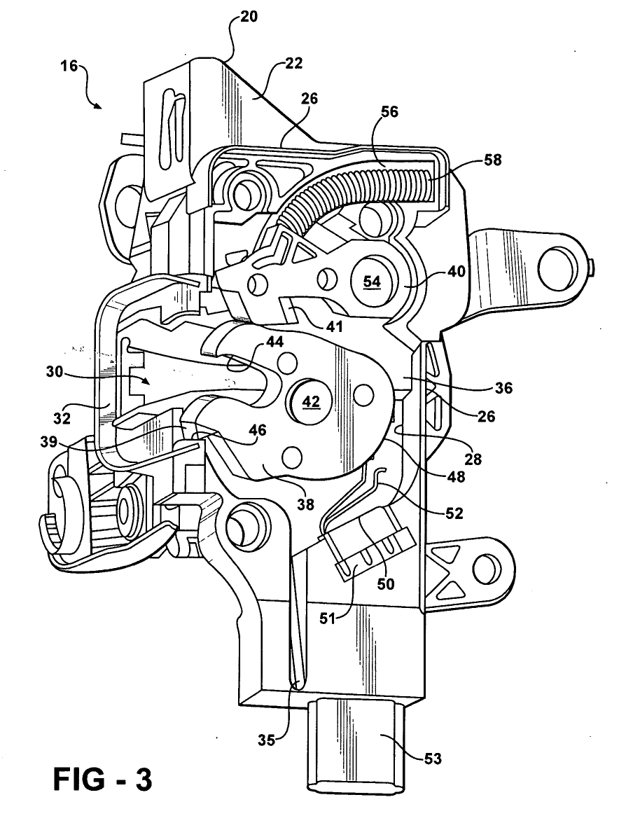

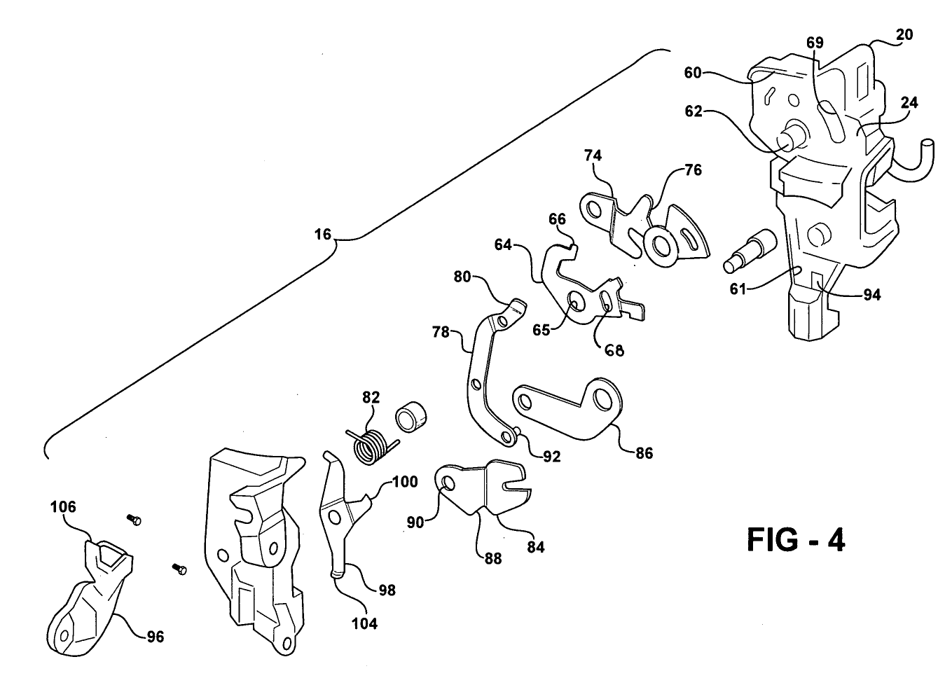

The latch assembly 16 includes a housing 20 having a first side 22, shown in FIGS. 2 and 3, and an opposing second side 24, shown in FIG. 4. Referring to FIGS. 2 and 3, a plurality of peripheral walls 26 extends along the first side 22 and defines a cavity 28. A frusto-trapezoidal aperture 30 bisects the first side 22. The aperture 30 is designed to receive the striker 18. A seal 32, preferably formed from a flexible rubber material, is mounted or otherwise integrally formed with the housing 20 at an open end of the aperture 30. An elastomeric or rubber bumper 34 including a shoulder 36 is fixedly mounted at an opposing end of the aperture 30 for receiving and absorbing the impact of the striker 18, thereby reducing stresses on the latch assembly 16 and reducing noise. A channel 35 extends from the cavity 28 of the first side 22 to the exterior of the housing 20 to provide a water outlet for the latch assembly 16.

A ratchet 38 and a ratchet-engaging pawl 40 are disposed within the cavity 28 formed along the first side 22 of the housing 20. The ratchet 38 and the ratchet-engaging pawl 40 are preferably constructed from metal and partially covered with a plastic material in order to reduce noise during latch operation. Certain portions that are subject to wear, such as a shoulder 39 of the ratchet 38 and a shoulder 41 of the ratchet-engaging pawl 40, are not covered by plastic.

The ratchet 38 is rotatably mounted to the first side 22 of the housing 20 via a pin 42 for movement between an engaged position (shown in FIG. 2), in which a hook portion 44 of the ratchet 38 engages the striker 18, and a release position (shown in FIG. 3), in which the ratchet 38 releases the striker 18 to allow opening of the door 14. A spring (not shown) biases the ratchet 38 into the release position. The angular travel of the ratchet 38 about the pin 42 is delimited by the shoulder 36 and a wall 46.

The ratchet 38 also includes a lip 48 for selectively engaging a switch 50 disposed within a recess 51. More specifically, as the ratchet 38 moves from the engaged position to the release position, the lip 48 urges against a leaf spring 52 in order to change the state of the switch 50. The switch 50 includes a plurality of terminals attached to a wiring harness (not shown) that is disposed in and extends from a tubular construct 53 formed in the housing 20.

The ratchet-engaging pawl 40 is rotatably mounted along the first side 22 of the housing 20 via a pin 54. When the ratchet-engaging pawl 40 is in a pawl engagement position, as shown in FIG. 2, the ratchet-engaging pawl 40 retains the ratchet 38 in the engaged position. When the ratchet-engaging pawl 40 is moved out of the pawl engagement position, the ratchet 38 is free to move from the engaged position to the release position. A spring 56 is disposed within a groove 58 for biasing the ratchet-engaging pawl 40 into the pawl engagement position.

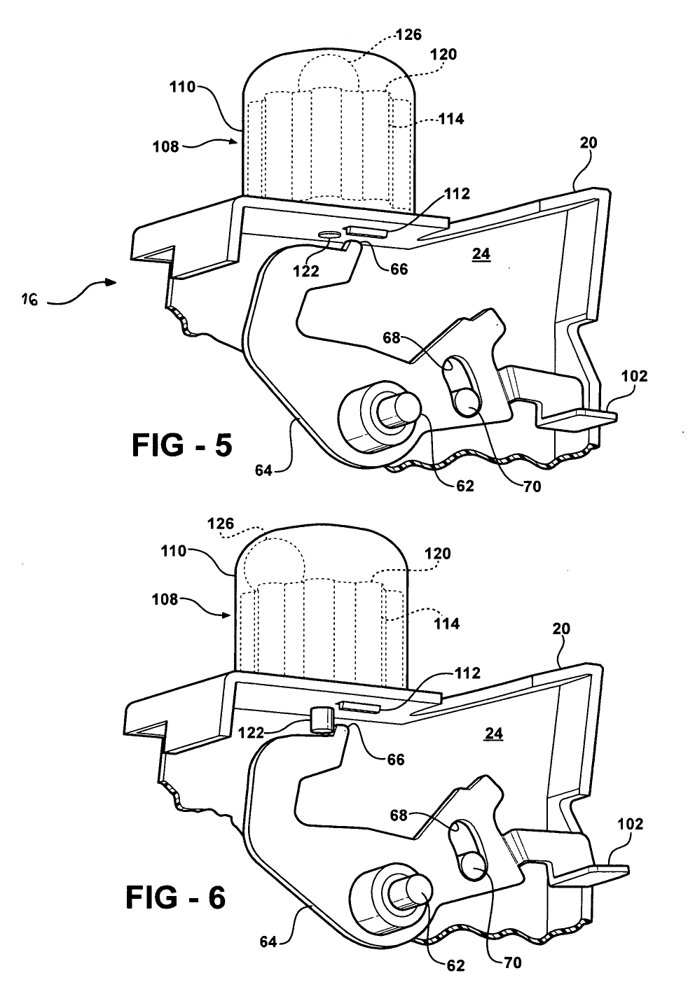

Referring to FIG. 4, the second side 24 of the housing 20 includes upper 60 and lower 61 cavities. A tubular post 62 is disposed within the upper cavity 60 and encompasses the pin 54 extending through the opposing first side 22 of the housing 20. An auxiliary pawl lever 64 is pivotally mounted about the tubular post 62 along the second side 24 of the housing 20. The auxiliary pawl lever 64 defines an aperture 65 for receiving the tubular post 62 therethrough and includes a protrusion 66. The auxiliary pawl lever 64 also includes a slot 68 that receives a projection 70, shown in FIGS. 5 through 8, of the ratchet-engaging pawl 40 extending through an opening 69 in the housing 20. Thus, the auxiliary pawl lever 64 is operably coupled to the ratchet-engaging pawl 40.

Referring again to FIG. 4, an outside release lever 74 is also pivotally mounted about the tubular post 62. The outside release lever 74 includes a slot 76 and is coupled to the auxiliary pawl lever 64 by a slidable link 78. The slidable link 78 includes a tab 80 that slides in and out of the slot 76. A toggle spring 82 biases the link 78 either into or out of the slot 76. When the tab 80 is adjacent an open end of the slot 76, the link 78 is in an unlocked position. When the link 78 is in the unlocked position, rotation of the outside release lever 74 causes the tab 80 to engage the auxiliary pawl lever 64, which causes the auxiliary pawl lever 64, and the ratchet-engaging pawl 40 coupled thereto, to rotate. As a result of this rotation, the ratchet-engaging pawl 40 moves out of the engagement position, which allows the ratchet 38 to move to the release position and release the striker 18. On the other hand, when the tab 80 is adjacent a closed end of the slot 76, the link 78 is in the locked position. When the link 78 is in the locked position, the outside release lever 74 will rotate relative to the auxiliary pawl lever 64 and the ratchet 38 remains in the engaged position.

The link 78 is actuated by a lock link lever 84, which in turn is actuated by a key cylinder lever 86 connected to a key cylinder (not shown). The lock link lever 84 includes a shelf 88 with side ridges. The key cylinder lever 86 is seated in the shelf 88 and has an angular freedom of motion of about 20 degrees (“lost motion”) before the key cylinder lever 86 engages one of the side ridges and imparts rotational motion to the lock link lever 84. The lock link lever 84 also includes an aperture 90, which receives a coupling projection 92 depending from the link 78. As a result, the link 78 is kinematically coupled to the lock link lever 84 and the key cylinder lever 86. Consequently, only a full rotation of the key cylinder lever 86 causes the link 78 to move between the locked and unlocked positions. A switch 94 is capable of indicating any of three positions of the key cylinder: neutral, unlock and lock.

An inside lock lever 96 and an inside release lever 98 are coupled to the key cylinder lever 86 and the auxiliary pawl lever 64, respectively. More specifically, the inside release lever 98 includes a foot 100 that abuts an appendage 102 of the auxiliary pawl lever 64. The inside release lever 98 also includes a toe 104 for engaging a pedal 106 of the inside lock lever 96 for unlocking the inside lock lever 96 when the inside release lever 98 is actuated.

Referring to FIGS. 5 through 8, the latch assembly 16 further includes an inertia mechanism, generally shown at 108, for preventing the ratchet 38 from releasing the striker 18 in the event of a motor vehicle impact or similar acceleration above a predetermined threshold. The inertia mechanism 108 includes a cover 110 that is fixedly secured to the housing 20 by a plurality of fasteners 112.

The inertia mechanism 108 also includes a body portion 114 surrounded by the cover 110 and disposed along a portion of the housing 20. An inner conical surface, generally indicated at 116, is formed at one end 117 of the body portion 114. The inner conical surface 116 includes a bottom 118 and an upper rim 120. The body portion 114 defines a groove 121 at an opposite end 119 of the inner conical surface 116.

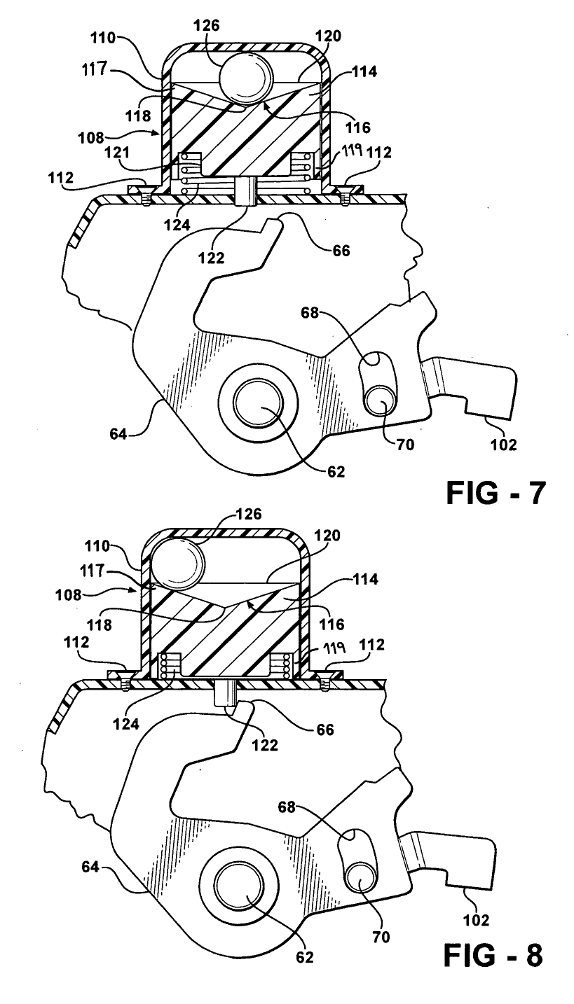

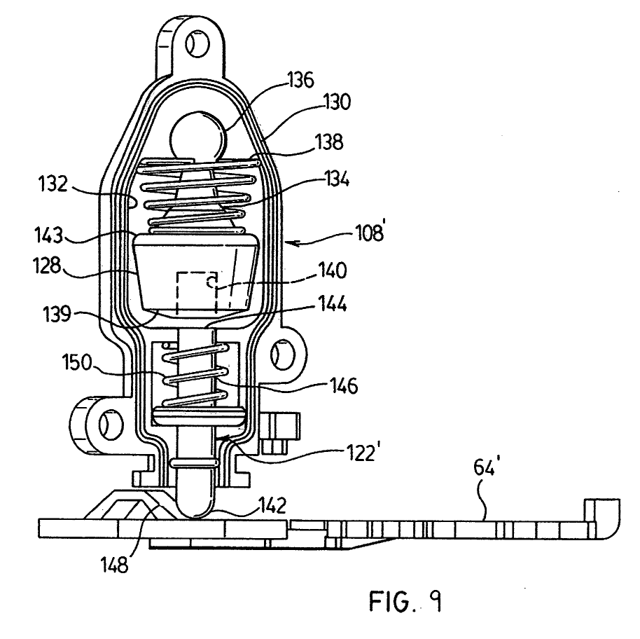

The inertia mechanism 108 further includes a plunger 122 extending out from the end 119 of the body portion 114. The plunger 122 is movable between a retracted position, shown in FIGS. 5 and 7, and an extended position, shown in FIGS. 6 and 8. When the plunger 122 is in the retracted position, the auxiliary pawl lever 64 is able to rotate unimpeded about the tubular post 62 in order to move the ratchet-engaging pawl 40 out of the pawl engagement position, which allows movement of the ratchet 38 from the engaged position to the release position. In the extended position, the plunger 122 engages the protrusion 66 of the auxiliary pawl lever 64 to prevent rotation thereof such that the ratchet-engaging pawl 40 is not able to move out of the pawl engagement position. A spring 124 is disposed within the groove 121 and biases the plunger 122 into the retracted position.

The inertia mechanism 108 includes a ball 126 disposed along the inner conical surface 116 of the body portion 114. The cover 110 maintains the ball 126 in contact with the inner conical surface 116. The motion of the ball 126 along the inner conical surface 116 causes the plunger 122 to move between the retracted and extended positions.

In normal conditions, the ball 126 is located at the bottom 118 of the inner conical surface 116. When the ball 126 is at the bottom 118 of the inner conical surface 116, the spring 124 is extended and the body portion 114 is raised so that the plunger 122 is in the retracted position. Therefore, the auxiliary pawl lever 64 is able to rotate unimpeded about the tubular post 62 in order to move the ratchet-engaging pawl 40 out of the pawl engagement position, which in turn allows the ratchet 38 to move from the engaged position to the release position.

In the event of a motor vehicle impact, however, the ball 126 is urged towards the upper rim 120 of the inner conical surface 116. The spring 124 compresses and the body portion 114 lowers, thereby moving the plunger 122 from the retracted position to the extended position, as shown in FIGS. 6 and 8, for engaging the protrusion 66 of the auxiliary pawl lever 64. As a result, the auxiliary pawl lever 64 is prevented from rotating about the tubular post 62, which in turn prevents the ratchet-engaging pawl 40 from moving out of the pawl engagement position. The ratchet 38 thus remains in the engaged position. Therefore, the striker 18 is not released and the door 14 does not inadvertently open from the motor vehicle impact.

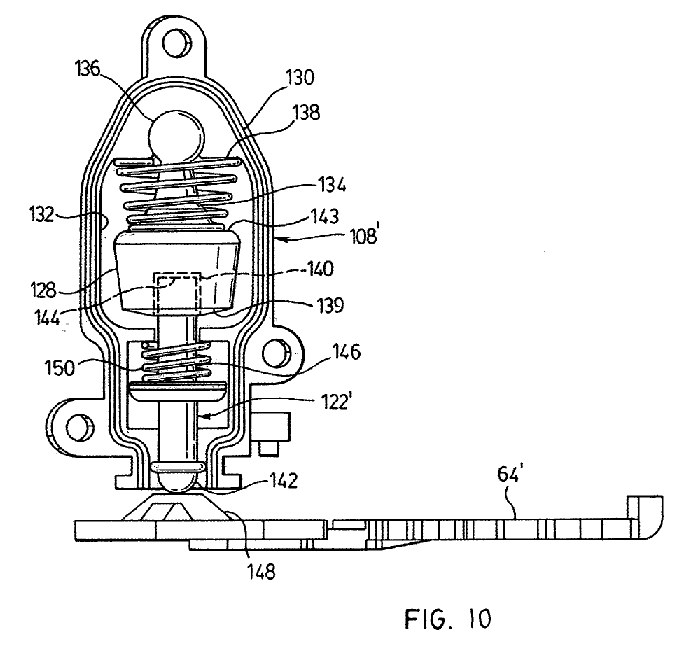

Referring to FIGS. 9 through 11, wherein like primed reference numerals represent similar elements as those set forth above, the inertia mechanism 108′ according to a second embodiment of the invention includes a bell member 128 disposed within a bell housing 130 having a peripheral wall 132. The bell housing 130 is fixedly secured to the housing 20′ adjacent the auxiliary pawl lever 64′. It is appreciated that a portion of the bell housing 130 has been cut away in FIGS. 9 through 11 for clarity.

The bell member 128 includes a top portion 134 terminating at a distal sphere 136. A centering spring 138 is disposed around the top portion 134 below the distal sphere 136 for biasing the bell member 128 into the center of the bell housing 130. The bell member 128 also includes a bottom surface 139 defining a cavity 140. One end of the centering spring 138 abuts the distal sphere 136 and an opposite end of the centering spring 138 abuts an intermediate surface 143 of the bell member 128.

The plunger 122′ includes a first end 142, an opposing second end 144, and a middle segment 146 disposed between the first 142 and second 144 ends. The first end 142 abuts a ramp 148 positioned along the auxiliary pawl lever 64′. The rotation of the auxiliary pawl lever 64′ about the tubular post 62′ moves the plunger 122′ from a neutral position, shown in FIG. 9, to a seated position, shown in FIG. 10, in which the second end 144 of the plunger 122′ is received within the cavity 140 of the bell member 128. A compression spring 150 is wrapped around the middle segment 146 of the plunger 122′ for biasing the plunger 122′ into the neutral position.

During normal operation, the auxiliary pawl lever 64′ is rotated as one of the outside 74′ and inside 98′ levers is actuated. The rotation of the auxiliary pawl lever 64′ urges the first end 142 of the plunger 122′ up the ramp 148, which in turn pushes the second end 144 of the plunger 122′ into the cavity 140 so that the plunger 122′ moves from the neutral position to the seated position. Thus, the auxiliary pawl lever 64′ is free to rotate, which urges the ratchet-engaging pawl 40′ out of the pawl engagement position. As a result, the ratchet 38′ is free to move from the engaged position to the release position and release the striker 18′.

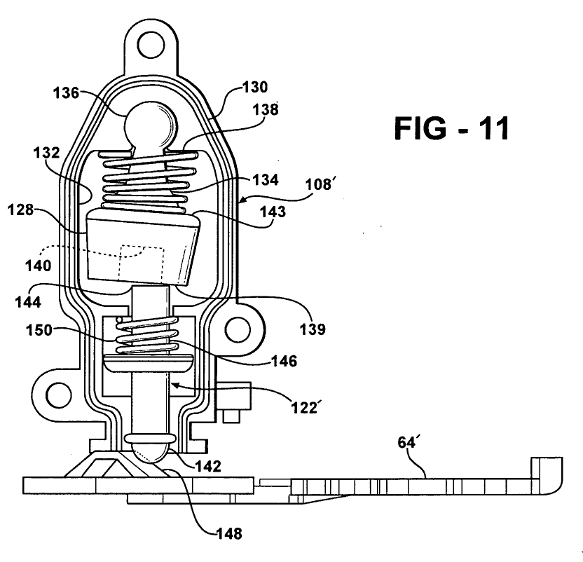

In the event of a motor vehicle impact, a portion of the bell member 128 is forced towards the peripheral wall 132 so that the cavity 140 is no longer aligned with the second end 144 of the plunger 122′, as shown in FIG. 11. Thus, as the auxiliary pawl lever 64′ begins to rotate as a result of the force of the motor vehicle impact, the second end 144 of the plunger 122′ will not enter the cavity 140. Instead, the second end 144 of the plunger 122′ will abut the bottom surface 139 of the bell member 128. As a result, the plunger 122′ is not able to move to the seated position. The plunger 122′ therefore engages the auxiliary pawl lever 64′ and prevents rotation thereof. As a result, the ratchet-engaging pawl 40′ is not allowed to move out of the pawl engagement position and the ratchet 38′ is not able to move to the release position. Once the impact forces have subsided, the centering spring 138 re-centers the bell member 128 to allow release of the ratchet 38′ during normal operation as described above.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A latch assembly selectively engaging a striker for latching a door to a motor vehicle body, said latch assembly comprising:
a housing;
a ratchet rotatably mounted to said housing for movement between an engaged position engaging the striker and a release position;
a ratchet-engaging pawl rotatably mounted to said housing and engageable with said ratchet to retain said ratchet in said engaged position; and
an inertia mechanism operably connected to said ratchet-engaging pawl to prevent said ratchet-engaging pawl from pivoting out of engagement with said ratchet when said ratchet-engaging pawl begins to pivot due to inertial forces acting thereupon.

2. A latch assembly as set forth in claim 1 including an auxiliary pawl lever operably coupled to said ratchet-engaging pawl for moving said ratchet-engaging pawl out of engagement with said ratchet to allow movement thereof from said engaged position to said release position.

3. A latch assembly as set forth in claim 2 wherein said inertia mechanism includes a plunger engageable with said auxiliary pawl lever for selectively preventing said auxiliary pawl lever from moving said ratchet-engaging pawl out of engagement with said ratchet.

4. A latch assembly as set forth in claim 3 wherein said inertia mechanism includes a body portion having a first end and an opposing second end fixedly secured to said plunger.

5. A latch assembly as set forth in claim 4 wherein said first end of said body portion includes an inner conical surface extending between an upper rim and a bottom.

6. A latch assembly as set forth in claim 5 wherein said inertia mechanism includes a ball disposed along said inner conical surface and movable from said bottom towards said upper rim in response to inertial forces acting upon said ratchet-engaging pawl in order to move said plunger into engagement with said auxiliary pawl lever and prevent rotation thereof.

7. A latch assembly as set forth in claim 6 wherein said inertia mechanism includes a cover for keeping said ball in contact with said inner conical surface.

8. A latch assembly as set forth in claim 7 wherein said inertia mechanism includes a spring biasing said body portion.

9. A latch assembly as set forth in claim 8 wherein said auxiliary pawl lever includes a protrusion extending out therefrom and engageable with said plunger.

10. A latch assembly as set forth in claim 3 wherein said inertia mechanism includes a bell member selectively receiving one end of said plunger.

11. A latch assembly as set forth in claim 10 wherein said auxiliary pawl lever includes a ramp disposed therealong.

12. A latch assembly as set forth in claim 11 wherein said plunger includes an opposing end abutting said ramp and movable therealong during rotation of said auxiliary pawl lever.

13. A latch assembly as set forth in claim 12 wherein said bell member defines a cavity in alignment with said plunger during normal latch operation for receiving said plunger therein to allow rotation of the auxiliary pawl lever and out of alignment with said plunger in the event of a motor vehicle impact to prevent rotation of said auxiliary pawl lever.

14. A latch assembly as set forth in claim 13 wherein said inertia mechanism includes a centering spring disposed around a portion of said bell member for biasing said bell member into alignment with said plunger.

15. A latch assembly as set forth in claim 14 wherein said inertia mechanism includes a compression spring for biasing said plunger away from said bell member.

16. A latch assembly selectively engaging a striker for latching a door to a motor vehicle body, said latch assembly comprising:
a housing;
a ratchet rotatably mounted to said housing for movement between an engaged position engaging the striker and a release position;
a ratchet-engaging pawl rotatably mounted to said housing and engageable with said ratchet to retain said ratchet in said engaged position;
an auxiliary pawl lever rotatably mounted to said housing and operably coupled to said ratchet-engaging pawl for moving said ratchet-engaging pawl out of engagement with said ratchet, said auxiliary pawl lever including a protrusion extending out therefrom; and
an inertia mechanism coupled to said housing and including a plunger movable in response to inertial forces to effect engagement between said plunger and said protrusion and prevent said auxiliary pawl lever from moving said ratchet-engaging pawl out of engagement with said ratchet.

17. A latch assembly selectively engaging a striker for latching a door to a motor vehicle body, said latch assembly comprising:
a housing;
a ratchet rotatably mounted to said housing for movement between an engaged position engaging the striker and a release position;
a ratchet-engaging pawl rotatably mounted to said housing and engageable with said ratchet to retain said ratchet in said engaged position;
an auxiliary pawl lever rotatably mounted to said housing and operably coupled to said ratchet-engaging pawl for moving said ratchet-engaging pawl out of engagement with said ratchet to allow movement of said ratchet to said release position; and
an inertia mechanism having a first end coupled to said auxiliary pawl lever and an opposing second end, said inertia mechanism including a bell member having a cavity for receiving said second end during normal latch assembly operation to allow rotation of said auxiliary pawl to move said ratchet-engaging pawl out of engagement with said ratchet, said cavity movable out of alignment with said second end of said plunger in response to inertial forces to prevent rotation of said auxiliary pawl lever.

18. A latch assembly as set forth in claim 17 wherein said auxiliary pawl lever includes a ramp disposed therealong for receiving said first end of said plunger thereagainst.
